(19) United States
(12) Patent Application Publication
(10) Pub. No.: US 2026/0104865 A1
(43) Pub. Date: Apr. 16, 2026

(54) GENERATIVE ARTIFICIAL INTELLIGENCE (GEN AI)-BASED MULTIAGENT CODE MIGRATION

(71) Applicant: ACCENTURE GLOBAL SOLUTIONS LIMITED, Dublin 4 (IE)

(72) Inventors: Duncan James GILLIES, Queensland (AU); Jean-Claude EL-SABBAGH, Carlingford (AU); Sarthak DAS, Notting Hill (AU); Mitchell John MCNAUGHTON, Mooroolbark victory (AU)

(73) Assignee: ACCENTURE GLOBAL SOLUTIONS LIMITED, Dublin 4 (IE)

(21) Appl. No.: 19/355,058

(22) Filed: Oct. 10, 2025

Related U.S. Application Data
(60) Provisional application No. 63/705,848, filed on Oct. 10, 2024.

(51) Int. Cl. G06F 8/35; G06F 11/3604

(52) U.S. Cl. CPC G06F 8/35; G06F 11/3608

(57) ABSTRACT

Systems and methods for Generative Artificial Intelligence (Gen AI)-based multiagent code migration are disclosed. In an aspect, source code is accessed along with a source code report specifying code issues that are to be remediated. Further, code issues to be remediate are identified in the source code. Furthermore, one or more Gen AI agents of a plurality of Gen AI agents are selected. Furthermore, corresponding prompts are built for the one or more Gen AI agents. The corresponding prompts are then transmitted to the one or more Gen AI agents along with source code snippets. In addition, outputs produced by the one or more Gen AI agents upon execution of the corresponding prompts are received. The outputs may include refactored source code snippets with the code issues remediated. Also, the refactored source code snippets are reassembled into the source code if that the code issues are remediated.

### CROSS-REFERENCE TO RELATED APPLICATION(S)

This application claims priority under 35 USC § 119(e) to a US Provisional Application No. 63/705,848, filed on Oct. 10, 2024, the entire content of which is hereby incorporated by reference in the entirety for all purposes.

### TECHNICAL FIELD

Various examples described herein relate generally to a method and system for code migration. Specifically, the disclosed examples are directed to techniques for Generative Artificial Intelligence (Gen AI)-based multiagent code migration.

### BACKGROUND

Large Language Models (LLMs) have recently demonstrated significant improvements in generating coherent, contextually appropriate, and human-like responses. The LLMs are increasingly being utilized across a range of domains, including natural language processing, code generation, business process automation, and decision support systems. The ability to process and generate text at scale makes the LLMs valuable tools for augmenting and automating complex workflows.

Despite the capabilities, existing LLM-based systems LLMs exhibit several inherent limitations that constrain safe and effective deployment in real-world applications. The LLMs are typically trained on large-scale datasets that may include sensitive, proprietary, or personally identifiable information. As a result, there exists a risk that the LLMs may memorize and unintentionally reproduce such data, raising significant privacy and compliance concerns. In addition to privacy risks, the LLMs are susceptible to bias. Since the LLMs learn directly from training data, the LLMs may inherit and amplify harmful societal or cultural biases present in the data. Moreover, static nature of LLM training means that once trained, the LLMs cannot automatically update their knowledge, leading to the possibility of generating responses that are outdated or misaligned with current information.

### SUMMARY

Implementations of the present disclosure are generally directed to systems and methods for code migration. Specifically, the disclosed examples are directed to techniques for Generative Artificial Intelligence (Gen AI)-based multiagent code migration.

In some examples, aspects of the subject matter described herein provide a Gen AI-based multiagent code migration system. In an aspect, the system includes at least one hardware processor and at least one non-transitory processor-readable medium storing a plurality of Gen AI agents that enable remediation of different types of code issues in source code, and instructions to be executed by the at least one hardware processor to execute a system prompt for a code refactoring agent from the plurality of Gen AI agents. The execution of the system prompt for the code refactoring agent further causes the at least one hardware processor to access the source code from a code repository along with a source code report specifying code issues that are to be remediated. Furthermore, the at least one hardware processor is configured to identify, by parsing the source code report, the code issues to be remediated in the source code.

Moreover, the at least one hardware processor is configured to select one or more Gen AI agents of the plurality of Gen AI agents. The one or more Gen AI agents are configured for remediating at least one of the code issues. In addition, the at least one hardware processor is configured to build corresponding prompts for the one or more Gen AI agents. The corresponding prompts may include source code snippets with the at least one code issue to be remediated by corresponding Gen AI agents of the one or more Gen AI agents. Also, the at least one hardware processor is configured to transmit the corresponding prompts to the one or more Gen AI agents. The at least one hardware processor is then configured to receive outputs produced by the one or more Gen AI agents upon execution of the corresponding prompts. The outputs include refactored source code snippets with the at least one code issue remediated. Further, the at least one hardware processor is configured to validate the refactored source code snippets. Furthermore, the at least one hardware processor is configured to reassemble the source code by replacing the source code snippets including the at least one code issue with the refactored source code snippets.

The present disclosure further describes a processor-executable method, executed by the at least one hardware processor provided herein, for performing Gen AI-based multiagent code migration. The present disclosure also describes non-transitory computer-readable medium coupled to the at least one hardware processor and having instructions stored thereon which, when executed by the at least one hardware processor, cause the at least one hardware processor to perform operations in accordance with the method described herein.

It is appreciated that method in accordance with the present disclosure can include any combination of the aspects and features described herein. That is, the method in accordance with the present disclosure is not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

Various examples in accordance with the present disclosure will be described with reference to the drawings, in which:

FIG. 1 depicts an example environment that may be used to execute implementations of the present disclosure.

FIG. 2 depicts an example architecture of a Generative Artificial Intelligence (Gen AI)-based code migration system, in accordance with implementations of the present disclosure.

FIG. 3 depicts an example architecture of a multiagent framework, in accordance with implementations of the present disclosure.

FIGS. 4A and 4B depict an example architecture of a code validation framework and a code remediation framework, in accordance with implementations of the present disclosure.

FIG. 5 depicts an example architecture of a code refactoring framework, in accordance with implementations of the present disclosure.

FIG. 6 is a flow diagram that represents an example method for performing Gen AI-based code migration, in accordance with implementations of the present disclosure.

FIG. 7 depicts a block diagram of an example computer system that may be used to implement the method for generating the industry-specific solutions using the collaborative AI agents, in accordance with implementations of the present disclosure.

Like reference numbers and designations in the various drawings indicate like elements.

### DETAILED DESCRIPTION

In the following description, various examples will be illustrated by way of example and not by way of limitation in the figures of the accompanying drawings. References to various examples in this disclosure are not necessarily to the same example, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Reference to any “example” herein (e.g., “for example,” “an example of,” by way of example,” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to;” it specifically indicates open-ended inclusion or membership in the so-described combination, group, series, and the like.

The term “a” means “one or more” unless the context clearly indicates a single element.

“First,” “second,” etc., re labels to distinguish components or blocks of otherwise similar names but does not imply any sequence or numerical limitation.

“And/or” for two possibilities means either or both stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring example examples.

The specification and drawings are to be regarded in an illustrative rather than a restrictive sense. It will, however, be evident that various modifications and changes may be made thereunto without departing from the broader spirit and scope as set forth in the claims.

This disclosure should be interpreted according to the exemplary definitions provided below. In case of a contradiction between the definitions in the definitions section and other sections of this disclosure, this section should prevail. In case of a contradiction between the definitions in this section and a definition or a description in any other document, including in another document incorporated in this disclosure by reference, this section should prevail, even if the definition or the description in the other document is commonly accepted by a person of ordinary skill in the art.

Implementations of the present disclosure provide a technique for performing Generative Artificial Intelligence (Gen AI)-based multiagent code migration. Traditional Gen AI applications often rely on a single, large model to perform complex, multi-step tasks, which can result in opaque decision-making, poor modularity, and difficulty in controlling or updating specific components of a system. The present disclosure addresses the limitations by decomposing such systems into a collection of task-specific Gen AI agents, each configured to perform a distinct role within a broader pipeline. The Gen AI agents may include agents for prompt generation, intent recognition, code refactoring, testing, documentation, validation, output verification, and refinement. Implementations of the present disclosure may allow task-specific agent specialization and incremental system upgrades, thereby avoiding need to retrain or redeploy an entire model for each update or modification.

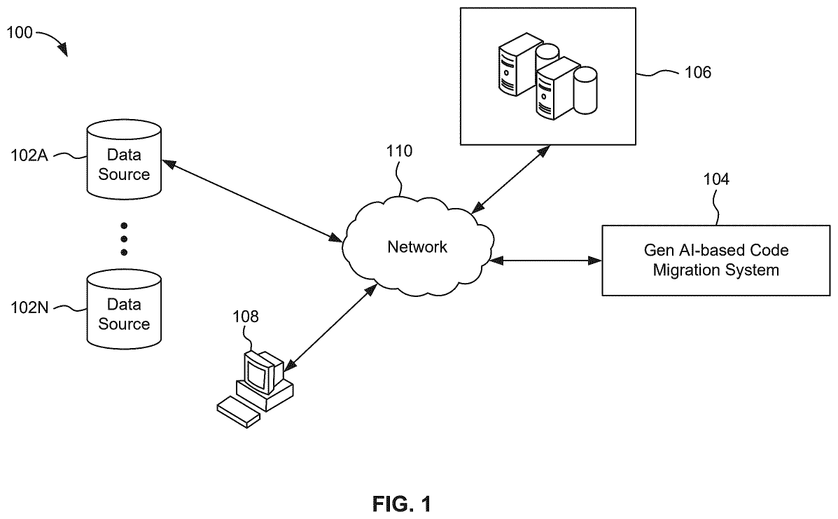

FIG. 1 depicts an example environment 100 that may be used to execute implementations of the present disclosure. The example environment 100, shown in FIG. 1, includes data sources 102A-N, a Gen AI based code migration system 104, a storage device 106 and a user device 108. For simplicity, a single user device 108 is depicted in FIG. 1, however it should be noted that the example environment 100 may include one or more user devices. The data sources 102A-N, the Gen AI based code migration system 104, the storage device 106 and the user device 108 may communicate with each other using a network 110. In some examples, the network 110 may include a Local Area Network (LAN), a Wide Area Network (WAN), the Internet, or a combination thereof. In some examples, the network 110 may be accessed over a wired and/or a wireless communication link.

The plurality of data sources 102A-N may include communication devices and/or computing devices that includes information corresponding to exhaustive inventory of data pipelines, files and datasets dependencies, code drift management and traceability. The plurality of data sources 102A-N may include a server such as a web server, a database server, a host server, a proxy server, a virtual server (e.g., executing on a computing hardware), or a server in a cloud computing system.

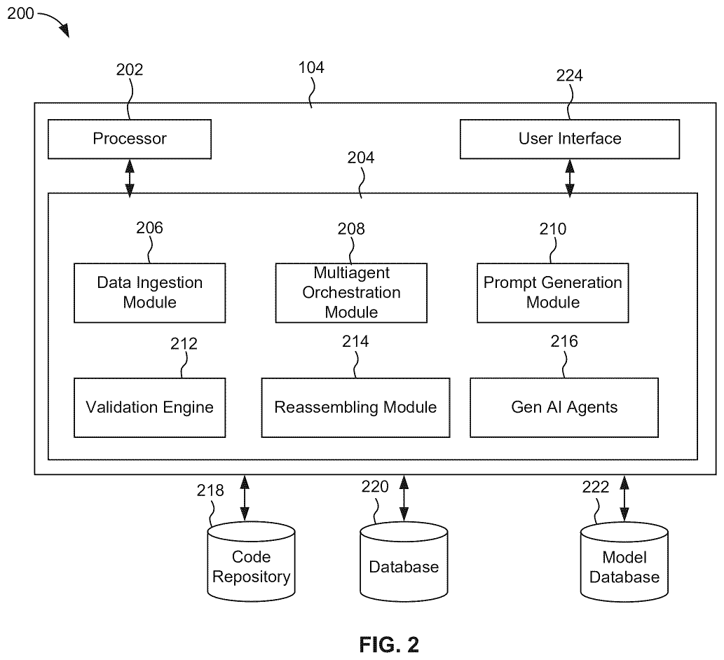

The Gen AI based code migration system 104 is a computing device or an application server that retrieves or obtains the data from the plurality of data sources 102A-N to perform code migration. The Gen AI based code migration system 104 may then process and store the migrated code in the storage device 106. In some examples, the Gen AI based code migration system 104 may include internal or external servers, quantum computers, desktops, laptops, smartphones, tablets, and/or the like. It is contemplated that implementations of the present disclosure may be realized with any appropriate type of computing device or computing platform. In some examples, the Gen AI based code migration system 104 may display one or more Graphical User Interfaces (GUIs) 218 that enable the user of the user device 108 to interact or provide feedback with a computing platform migrating the code. Examples of the computing platform may include content delivery platforms, multimedia-based platforms, and/or the like. Interacting with the computing platform may include providing feedback during the process of Gen AI-based multiagent code migration. For example, the Gen AI based code migration system 104 is described in more detail with reference to FIG. 2.

While only one Gen AI based code migration system 104 is shown in FIG. 1, there may be more than one Gen AI based code migration system 104, and each of the Gen AI based code migration system 104 includes at least one server system. In some examples, the system hosts one or more computer implemented services that users can interact with by using the user device 108. For example, components of enterprise systems and applications can be hosted on one or more of the Gen AI based code migration system 104. In some examples, the Gen AI based code migration system 104 can be provided as an on-premises system that is operated by an enterprise or a third-party taking part in cross-platform interactions and data management. In some examples, the Gen AI based code migration system 104 can be provided as an off-premises system (e.g., cloud or on-demand) that is operated by an enterprise or a third-party on behalf of an enterprise.

In some examples, the user device 108 may include computer executable applications executed thereon. The user device 108 may include a web browser application executed thereon, which can be used to display one or more web pages of applications executing on the Gen AI based code migration system 104. In some examples, the user device 108 can display one or more GUIs that enable the respective the users to interact with the Gen AI based code migration system 104 and/or to present the migrated code. In accordance with implementations of the present disclosure, the Gen AI based code migration system 104 may host enterprise applications or systems that require data sharing and data privacy.

In some implementations, the Gen AI based code migration system 104 can be implemented in a cloud environment. In the example of FIG. 1, the Gen AI based code migration system 104 can include various forms of servers including, but not limited to, a web server, a proxy server, a network server, and/or a server pool. In general, server systems accept requests for application services and provide such services to any number of user devices.

Further, the storage device 106 may include any standalone server or any type of computing device that is part of a cloud computing environment for storing data that is ingested by processing the source code. Various examples depicting the process of Gen AI-based multiagent code migration are described in detail in conjunction with FIGS. 2-5.

FIG. 2 depicts an example architecture 200 of the Gen AI based code migration system 104, in accordance with implementations of the present disclosure. As depicted in FIG. 2, the Gen AI based code migration system 104 is communicatively coupled to a database 220 (e.g., the storage device 106) and a model database 222. For example, the database 220 can be a client database or a metadata database. In some examples, the model database 222 may include one or more Multimodal Large Language Models (multimodal LLMs) (also referenced herein as Gen AI models, foundation models, and/or the like). In an implementation, the LLMs may include pre-trained LLMs and generated LLMs. The pre-trained LLMs may be general-purpose Gen AI models like large deep learning neural networks, which may be trained using a broad range of generalized and unlabeled training data to perform one or more tasks, such as, human computer interactions (e.g., question and answering), automating process execution, process planning, generating step-by-step procedures for the process execution, performing data analysis, and/or the like. While implementations of the present disclosure are described in further detail herein with non-limiting reference to the LLMs, it is contemplated that implementations of the present disclosure may be realized using any appropriate foundation models or Machine Learning (ML) models, or AI models.

As depicted in FIG. 2, the Gen AI based code migration system 104 includes a processor 202 and a memory 204. The Gen AI based code migration system 104 may also include other components such as communication interfaces, Input/Output (I/O) devices, and so on (not shown in FIG. 2). The processor 202 may include one or more processors. Examples of the one or more processors may include, but not limited to, microprocessors, microcomputers, microcontrollers, digital signal processors, central processing units, state machines, logic circuits, Application Specific Integrated Circuits (ASICs), Field Programmable Gate Arrays (FPGAs), and/or any devices that manipulate data or signals based on operational instructions. Among other capabilities, the processor 202 may be programmed to execute computer-readable instructions or processor-readable instructions stored in the memory 204 (also referenced herein as computer-readable storage medium (CRM)) for performing operations according to the present disclosure. The memory 204 may be non-transitory or non-volatile medium, such as a magnetic disk or solid-state non-volatile memory or volatile medium such as Random Access Memory (RAM), and/or the like.

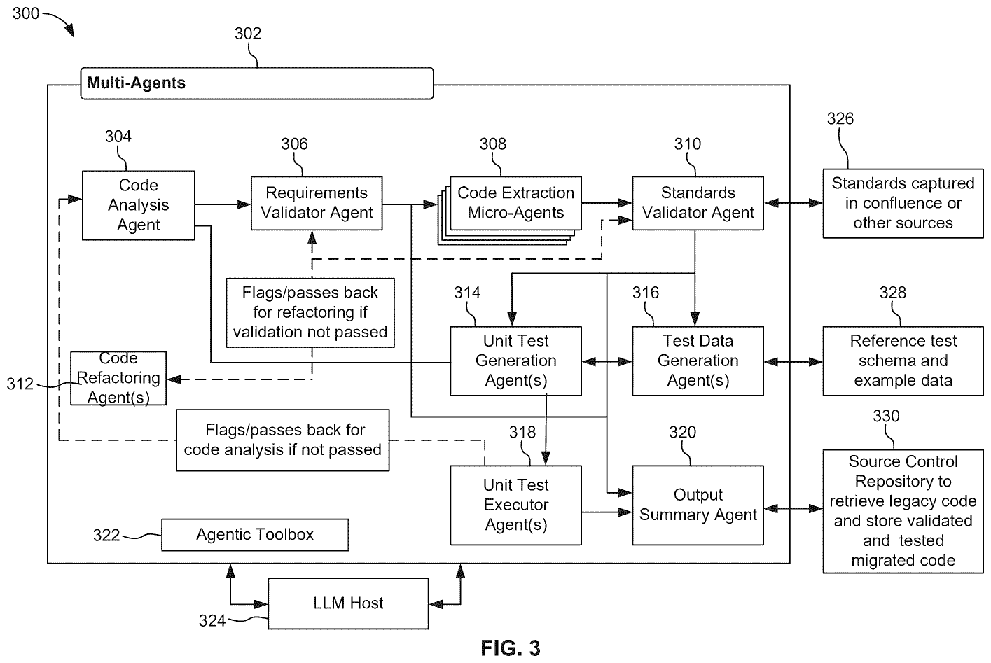

The system 104 further includes a data ingestion module 206, a multiagent orchestration module, a prompt generation module 210, a validation engine 212, and a reassembling module 214, as depicted in FIG. 2. The data ingestion module 206, the multiagent orchestration module, the prompt generation module 210, the validation engine 212, and the reassembling module 214 may be stored in the memory 204 and provided as a downloadable library including the computer-readable instructions. The data ingestion module 206, the multiagent orchestration module, the prompt generation module 210, the validation engine 212, and the reassembling module 214 may be executed by the processor 202 communicatively coupled with the memory 204 for performing Gen AI-based multiagent code migration. In some examples, a plurality of Gen AI agents 216 may be stored in the memory 204 and provided as a downloadable library including the computer-readable instructions. The plurality of Gen AI agents may enable remediation of different types of code issues in source code. Example interaction between the Gen AI agents for enabling remediation of different types of code issues in the source code is explained in more detail with reference to FIG. 3. In an aspect, the plurality of Gen AI agents may include one or more multi-purpose agents activated for the code issues. For example, the Gen AI agents 216 may include autonomous agents or specialized agents, such as a code refactoring agent, a code extractor agent, functional analysis agent, a manager agent, a code reviewing agent, a code synthesizer, code developing agents, import statement expert agents, a parameters expert agent, a design expert agent and the like and are implemented as containerized microservices that execute on external computing devices or within the system 104. The agents 216 are in network communication with the data ingestion module 206, the multiagent orchestration module, the prompt generation module 210, the validation engine 212, and the reassembling module 214 via Application Programming Interfaces (APIs) or message queues. In some examples, the AI agents 216 may be stored in and executed directly from the memory 204 of the system 104. In this case, inter-agent communication may be facilitated via internal process calls, local sockets, or memory buses.

In an example implementation, the processor 204 is configured to execute a system prompt for the code refactoring agent from the plurality of Gen AI agents 216. In an aspect, the data ingestion module 206 may access the source code from a code repository 218 along with a source code report specifying code issues that are to be remediated. For example, the code repository 218 is a central location where the source code is stored, managed, and tracked, usually using a version control system. In some examples, the data ingestion module 206 may encode documents from Retrieval-Augmented Generation (RAG) using an embedding model to access the source code.

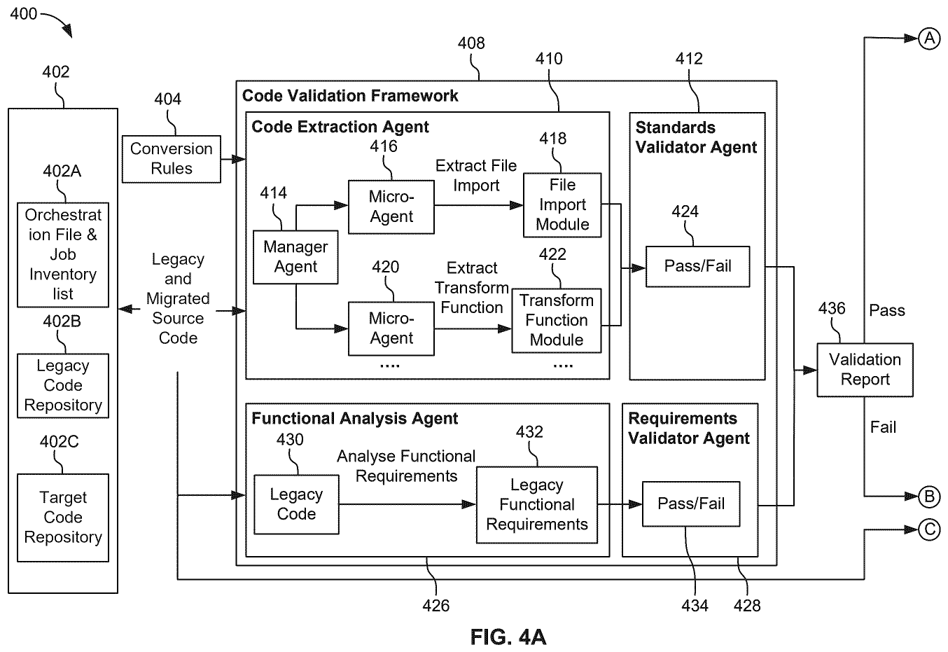

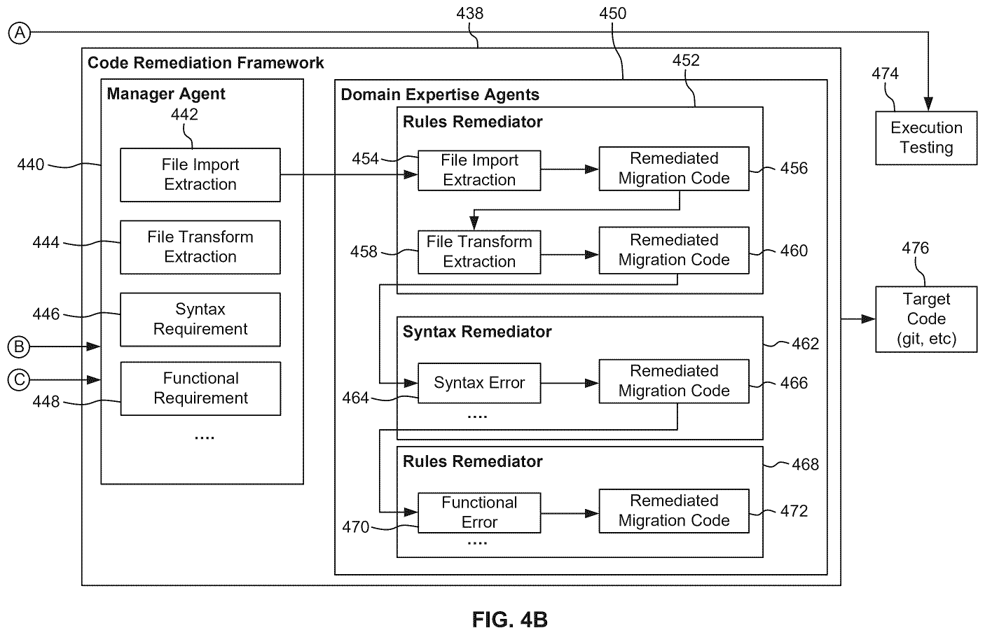

Further, the data ingestion module 206 may identify, by parsing the source code report, the code issues to be remediated in the source code. For example, the source code report may include structured or semi-structured data (e.g., Extensible Markup Language (XML), or plain text logs) containing diagnostic entries such as syntax errors, type mismatches, unused variables, deprecated API usage, performance bottlenecks, security vulnerabilities (e.g., hardcoded credentials, unsanitized inputs), syntax corrections, naming convention checks, readability improvements and rule enforcement. The data ingestion module 206 may include a parsing engine that tokenizes the source code report and applies rule-based or pattern-matching logic to extract relevant metadata such as file paths, line numbers, error codes, severity levels, and recommended fixes. In certain implementations, natural language processing (NLP) techniques or large language models (LLMs) may be used to interpret human-readable parts of the report (e.g., warnings or remediation suggestions). The extracted information may then be normalized into a structured format, such as an internal remediation issue schema, which can be consumed by downstream Gen AI agents in the multi-agent system (e.g., a remediation agent or the code refactoring agent). The parsing enables the system to programmatically identify and prioritize issues for automated correction, guided repair, or developer review. In this example, different types of code issues may include execution errors, code quality errors, inconsistencies requiring manual review, security vulnerabilities, performance inefficiencies and the like. The security-related issues may include presence of hardcoded credentials, such as passwords or API keys and the like. The performance issues may involve inefficient use of memory or CPU resources, such as the repeated instantiation of objects inside loops, unbuffered file I/O operations, use of blocking functions within asynchronous workflows, logical errors and the like. In an aspect, to access the source code report, the data ingestion module 206 may execute rule-based and semantic validation over the source code and classify the at least one code issue into one or more of the different types of code issues. The process of validation is explained in more detailed with reference to FIG. 4.

Furthermore, the multiagent orchestration module 208 may select one or more Gen AI agents of the plurality of Gen AI agents. For example, the plurality of Gen AI agents may implement different types of LLMs stored in the model database 222. The one or more Gen AI agents are configured for remediating at least one of the code issues. In an aspect, the multiagent orchestration module 208 may identify corresponding ones of the one or more Gen AI agents that are configured for remediating types of the one or more code issues identified in the source code. In another aspect, the multiagent orchestration module 208 may select the one or more Gen AI agents based on one or more attributes associated with the identified code issue, such as issue type (e.g., security, performance, style), severity level, affected programming language, file context, or remediation history.

In addition, the prompt generation module 210 may build corresponding prompts for the one or more Gen AI agents. The corresponding prompts may include source code snippets with the one or more code issues to be remediated by corresponding Gen AI agents of the one or more Gen AI agents. Moreover, the prompt generation module 210 may transmit the corresponding prompts to the one or more Gen AI agents. For example, the prompt generation module 210 may transmit the corresponding prompts to the one or more Gen AI agents via LLM APIs. Also, the prompt generation module 210 may receive outputs produced by the one or more Gen AI agents upon execution of the corresponding prompts. The outputs include refactored source code snippets with the at least one code issue remediated.

In an example implementation, the prompt generation module 210 may execute a prompt generated by the code refactoring agent for an import statement expert agent for correcting incorrect import statements in the source code. For example, the one or more of the import statement expert agents are configured for remediating import statements. Further, to correct the incorrect import statements, it is determined that a task for correcting incorrect import statements is delegated by the code refactoring agent. A prompt template for import-related refactoring is the loaded. Further, a structured prompt and a snippet of the source code including the incorrect import statements is provided to an LLM implemented by the import statement expert agent. The remediated source code snippets including corrected import statements are then transmitted to the code refactoring agent.

In another example implementation, the prompt generation module 210 may execute a prompt generated by the code refactoring agent for a parameters expert agent that remediates function parameter issues in the source code. In this example implementation, one or more source code snippets including the function parameter issues are received at the parameters expert agent, A tailored prompt for parameter repair is then loaded. Further, one or more source code snippets with the function parameter issues remediated are generated. The one or more remediated source code snippets including remediated function parameter issues are then transmitted to the code refactoring agent.

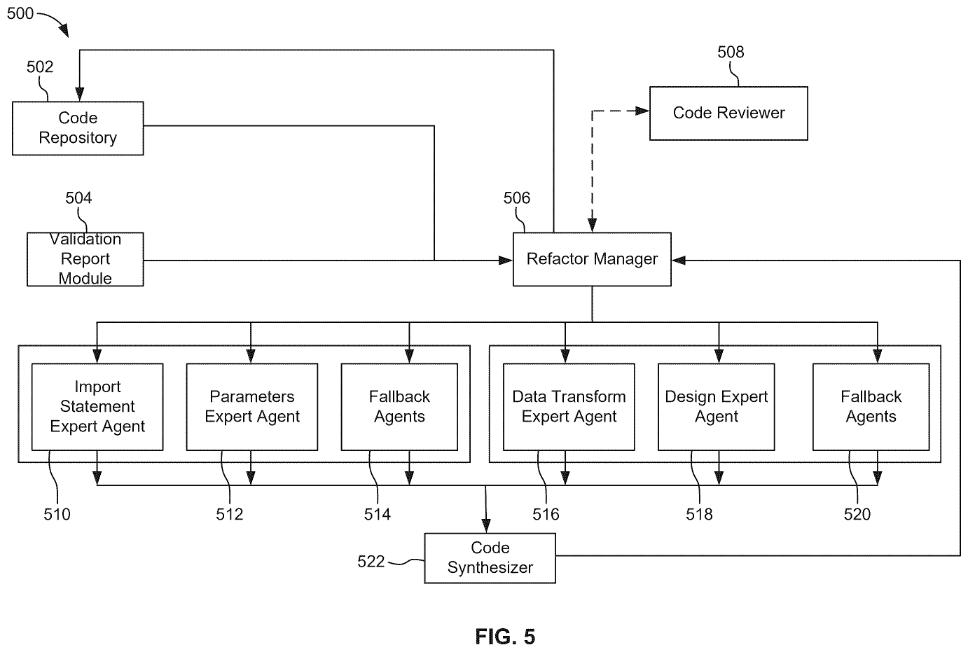

In yet another example implementation, execute a prompt generated by the code refactoring agent for a design expert agent that remediates design issues in the source code. In an aspect, one or more of class structure, object hierarchy and reuse patterns are evaluated in source code snippets to be remediated. Design-specific rules retrieved from a rules file and semantic prompts from the prompt generated by the code refactoring agent are then applied. Further, the design issues based on the rules file and the semantic prompts are remediated. The remediated source code snippets are then transmitted to the code refactoring agent with design issues remediated. This is explained in more detail with reference to FIG. 5.

Further, the validation engine 212 may validate the refactored source code snippets. In some examples, the validation engine 212 may validate the refactored source code snippets by performing one or more automated and/or programmatic checks to ensure that modifications introduced during remediation do not introduce new errors and that the refactored source code snippets conform to intended quality, functionality, and security standards. In an aspect, the validation engine 212 may execute syntax validation by parsing the refactored code using language-specific compilers, interpreters, or linters to detect any syntactic or semantic errors. Furthermore, the reassembling module 214 may reassemble the source code by replacing the source code snippets including the one or more code issues with the refactored source code snippets based on validation. In some examples, the reassemble code is a code that suits a target platform.

FIG. 3 depicts an example architecture of a multiagent framework 300, in accordance with implementations of the present disclosure. Particularly, the multiagent framework 300 may include a set of coordinated Gen AI agents 302 deployed within a runtime environment (e.g., Azure Machine Learning (ML)), managed by a central orchestration framework capable of invoking, sequencing, and monitoring agent execution paths. For example, the multiagent framework 300 is orchestrated by a LLM host 324, which may be implemented using models, such as OpenAI or other foundation models stored in the model database 222. The framework 300 is built upon a collection of Gen AI agents 302, each responsible for a discrete and well-defined task during code migration. The process is inherently iterative and fault-tolerant, enabling continuous refactoring and validation until the source code is production-ready. The agents 302 are organized into functional archetypes including retrieval and analysis agents (e.g., a code analysis agent 304), test generation agents (e.g., a unit test generation agent(s) 314), testing agents (e.g., a unit test executor agent(s) 318), test data generation agents(s) 316, validation agents (e.g., a requirements validator agent 306, code extraction micro-agents 308 and a standards validator agent 310), developer agents (e.g., code refactoring agent(s) 312) and traceability agents (e.g., an output summary agent 320).

In an example implementation the a code analysis agent 304 receives legacy and migrated source code from a version control or source control repository 330 (e.g., the code repository 218). The code analysis agent 304 may analyze the legacy and migrated source code to extract functionality summaries. In an aspect, the analysis may include logic tracing, function mapping, and variable tracking to build a representation of what the legacy code does, which is then compared against the migrated version to detect any deviations or regressions. The summaries produced are passed to downstream agents for validation purposes and serve as a baseline for testing.

Further, the requirements validator agent 306 compares the functionality summaries with the migrated code to ensure that all legacy requirements, both functional and non-functional, are preserved in the migrated version. If any mismatches or omissions are detected, the requirements validator agent 306 may flag an issue and routes the code to the code refactoring agent(s) 312. The refactoring agent 312 rewrites the code to meet the missing or non-compliant requirements of a target platform and then reinitiates the validation loop from the code analysis step. The refactoring logic may use prompt-based generation techniques, semantic diffing, and memory-augmented retrieval from prior successful patterns stored in the agent memory.

Furthermore, to support structured validation, the set of code extraction micro-agents 308 runs iteratively and are used to work in parallel, each focusing on a specific coding standard, best practice, or an expert approved guideline. For example, one micro-agent may analyze variable naming conventions, another might inspect indentation and formatting, and a third may validate design patterns. The micro-agents 308 may extract split the code into chunks or fragments of code based on standards and output structured data, typically in JavaScript Object Notation (JSON) format, which is aggregated and passed to the standards validator agent 310.

In addition, the standards validator agent 310 receives the structured extraction from the micro-agents 308 and validates the migrated code against organizational coding standards, which are maintained in external repositories such as confluence, GitLab wikis, or similar systems 326. The standards validator agent 310 may ensure that the migrated code adheres to required conventions, such as secure coding guidelines, exception handling standards, or memory optimization rules. If the code fails the validation, it is flagged and routed back to the code refactoring agent(s) 312. The refactored version is then revalidated by the requirements validator agent 306 until the code satisfies all standards.

Once the code passes both requirements and standards validations, the test data generation agent(s) 316 may create synthetic test datasets based on reference schemas and examples stored in a test data repository 328. The test datasets are used to simulate real-world inputs, edge cases, and negative scenarios. The dataset creation can be schema-driven (using JSON Schema and the like), or learned from historical production datasets using generative models stored in the model database 222.

Following data preparation, the unit test generation agent(s) 314 may utilize the functionality summaries (from the agent 304), the validated code, and the synthetic test datasets to automatically generate unit tests. The unit tests may be built using testing frameworks and are structured to ensure full code coverage, path condition testing, and regression checking. The unit test generation agent(s) 314 may use prompt engineering and Retrieval-Augmented Generation (RAG) to leverage prior test templates from an agentic toolbox 322.

Once generated, the unit tests are executed by the unit test executor agent(s) 318 in isolated and controlled environments. The unit test executor agent(s) 318 may run the unit test, capture execution logs, and determine pass or fail statuses. If any test fails, detailed feedback is extracted, and the failed code is sent back for the code refactoring agent 312, initiating another cycle through the analysis and validation chain. The loop continues until all tests pass successfully, thereby ensuring robustness and compliance of the migrated code.

Upon successful execution of the unit tests, the output summary agent 320 is invoked to compiles all validation results, test outcomes, and metadata into a structured report, which includes traceability from requirements to implementation to validation. The structured report, along with the validated and tested migrated source code, is stored in the source control repository 330. The repository 330 serves as a central location for deployment, audit, and future analysis.

In some examples, the multiagent framework 300 may rely on the agentic toolbox 322 which is a shared utility layer containing reusable components such as source code parsers, document retrievers (for Confluence, Wikis), code transformation functions, and memory-attached tools. The agentic toolbox 322 may ensure that each agent is able access to standard utilities or call any functions to perform respective operations efficiently. Thus, the multiagent framework 300 may significantly improves the efficiency, accuracy, and compliance of software code migration and modernization tasks.

FIGS. 4A and 4B depict an example architecture 400 of a code validation framework 408 and a code remediation framework 438, in accordance with implementations of the present disclosure. In an example implementation, the code validation framework 408 may validate syntactic integrity and functional correctness of both legacy and migrated source code by leveraging a combination of static analysis, domain knowledge, and business rules. The code validation framework 408 receives input from an enterprise database 402 (e.g., the database 220) storing knowledge graphs that encode code structures, relationships, and metadata. The database 402 may include orchestration file and job inventory lists 402A which provide execution context and dependencies, a legacy code repository 402B that stores an original or legacy source code and a target code repository 402C that stores migrated code. Further, the code validation framework 408 may validate the legacy and migrated source code received from the database 402 is according to a predefined set of conversion rules 404 using a set of validation agents. For example, the set of validation agents include code extraction agent 410 (e.g., the code extraction micro-agents 308), a functional analyses agent 426, a standards validator agent 412 (e.g., the standards validator agent 310) and a requirements validator agent 428 (e.g., the requirements validator agent 306).

In an example implementation, the code extraction agent 410 includes a manager agent 414 and multiple micro-agents 416, 420, each responsible for extracting specific code structures. In an aspect, the micro-agents may split the code into smaller chunks according to migration standards and conversion rules outlined in confluence. For example, the micro-agent 416 is configured to extract file import logic and an output (i.e., the extracted file import) is stored in a file import module 418. The micro-agent 420 may extracts transformation related functions and outputs the results (i.e., the transform functions) to a transform function module 422. The extracted code artifacts (i.e., the file import and transform functions) are then evaluated by the standards validator agent 412, which applies a set of rules and policies to determine syntactic and structural correctness. The validation result is provided as a pass or fail outcome 424, indicating whether the extracted code segments conform to predefined standards.

Also, the functional analysis agent 426 receives the legacy source code or legacy code 430 and performs deep analysis to infer functional behavior and derive corresponding legacy functional requirements 432. The requirements 432 are then compared against the transformed code by the requirements validator agent (428), which determines whether intended functionality has been preserved during transformation. The outcome of the comparison is also a pass or fail status 434. All validation outputs are then consolidated into a validation report 436, which includes both structural and functional assessment results. The report 436 determines whether the code passes validation and is suitable for deployment, or whether the code need to be returned for additional remediation. If the validation is passed, the validation framework 408 may proceed to execution testing 474. Else, the validation framework 408 may transmit the validation report 436 to the code remediation framework 438 (i.e., the framework 500). The code validation framework 408 thus ensures that legacy or transformed code meets required quality, functionality, and compliance standards before final deployment.

Furthermore, the code remediation framework 438 is configured to facilitate the automated identification and remediation of various types of issues in legacy or migrated source code based on the validation report 436. The code remediation framework 438 may include a manager agent 440 (i.e., the code refactoring agent(s) 312 and a set of domain expertise agents 450, which collectively operate to analyze, classify, and correct code deficiencies prior to code validation and deployment. The manager agent 440 acts as a central control unit and sorts code errors based on error domain. Specifically, the manager agent 440 may sort issues associated with file import extraction 442, file transform extraction 444, syntax requirements or error 446 and functional requirements or errors 448.

Upon identifying the code issues, the manager agent 440 may communicate the issues to the domain expertise agents 450, which include a set of remediation agents. Each of the remediation agents is tailored to resolve specific categories of code problems. In an aspect, a rules remediator 452 is configured to process file import issues 454 and outputs corrected source code as remediated migration code 456. Further, the rules remediator 452 addresses transformation logic inconsistencies and produces corresponding corrected code 460. A syntax remediator 462 may then processes syntax errors 464 and outputs syntactically valid code (i.e., remediated migration code) 466. In addition, a functional remediator 468 is responsible for resolving functional logic discrepancies identified as functional errors 470 and produces functionally compliant migration code 472.

Following the remediation steps, the generated code outputs 456, 460, 466, 472 are forwarded to an execution testing module 474, wherein the code is executed in a test or staging environment to validate operational integrity, runtime behavior, and expected output consistency. Upon successful execution testing, the validated and remediated code 476 is generated. The code remediation framework 438 thus ensures that legacy or transformed code is structurally and syntactically correct, and functionally consistent before integration into production systems or subsequent validation frameworks.

FIG. 5 depicts an example architecture of a code refactoring framework 500, in accordance with implementations of the present disclosure. In an aspect, the code refactoring framework 500 may include a code repository 502 (e.g., the code repository 218), an validation report module 504, a refactor manager 506 (e.g., the code refactoring agent(s) 312), a code reviewer 508, a plurality of Gen AI developer agents (including an import statements expert agent 510, a parameters expert agent 512, a data transform expert agent 516, a design expert agent 518, fallback agents or multi-purpose agents 514 and 520 and the agents 450), and a code synthesizer 522. For example, the import statement expert agent 510, the parameters expert agent 512 and the fallback agents 514 are expert agents in resolving standard issues. Also, the data transform expert agent 516, the design expert agent 518 and the fallback agents 520 are expert agents in resolving functional requirements issues.

In an example implementation, the prompt generation module 210 may execute a prompt that enables the refactor manager 506 to perform code refactoring process. In this example implementation, the refactor manager 506 may load configurations (such as file paths, agent definitions, LLM endpoint parameters, and rule paths) and initialize remediation process with execution parameters. The refactor manager 506 then parses a validation report from the validation report module 504 (i.e., a report generated by the requirements validator agent 306 and the standards validator agent 310) to identify individual code issues. For each issue, the refactor manager 506 determines which agent is responsible based on issue type and domain expertise. The refactor manager 506 then builds prompts and dispatches tasks to the selected agents via LLM APIs using a delegate_task_to_agent( ) method.

In an example implementation, the prompt generation module 210 may be configured to enable the refactor manager 506 execute a prompt for the import statement expert agent 510 for correcting incorrect import statements in the source code. More particularly, upon detecting via the validation report from the validation report module 504 that one or more import statements in the source code are missing, incorrect, or redundant, the refactor manager 506 delegates a task to the import statement expert agent 510. The import statement expert agent 510, in turn, determines that the task for correcting incorrect import statements is delegated and loads a prompt template for import related refactoring (e.g., from a function user_prompts.yaml). Further, the import statement expert agent 510 provides a structured prompt together with a snippet of the source code including the incorrect import statements to an LLM stored in the model database 222. The import statements expert agent 510 returns remediated source code snippets including corrected import statements and transmits the corrected snippets to the refactor manager 506.

Further, for at least one validation issue corresponding to function or method parameter mismatch or issues, the refactor manager 506 executes a prompt for the parameters expert agent 512. In such a case, the parameters expert agent 512 receives one or more source code snippets that include the detected parameter issues, loads a tailored prompt configured for parameter repair, and generates the one or more source code snippets with the function parameter issues remediated. The parameters expert agent 512 then transmits the remediated snippets to the refactor manager 506.

Moreover, for one or more architectural or design issues detected in the validation report (such as class hierarchy, reuse patterns, or module structure), the refactor manager 506 executes a prompt for the design expert agent 518. The design expert agent 518 evaluates one or more of class structure, object hierarchy, and reuse patterns present in the source code snippets to be remediated. Further, the design expert agent 518 applies design-specific rules (such as rules loaded from rules.yaml) and semantic prompts included in the prompt generated by the refactor manager 506. Also, the design expert agent 518 remediates the design issues in the source code and transmits remediated source code snippets to the refactor manager 506.

Also, to address and correct issues specifically related to transformation logic within the source code, a prompt is executed for the data transformation expert agent 516 by the refactor manager 506. Typical use cases include semantic conversions between programming paradigms, such as SQL-to-Python, or translating data manipulation logic from one language or framework to another.

Upon activation, the data transformation expert agent 516 receives two primary inputs including an original transformation logic (referred to as a “transformation block”) and a structured or semi-structured description of the issue or defect associated with the block. The issue metadata can originate from static analysis tools, error logs, or user annotations. The transformation block is typically expressed in a source language and may contain logical errors, deprecated syntax, or mismatched data references. To perform the correction, the data transformation expert agent 516 is instantiated using configurations defined in a declarative file (agents.yaml), which specifies the role, behavior, and system-level parameters of the agent. Further, prompts for the data transformation expert agent 516 are dynamically assembled by interpolating the original transformation logic and issue metadata into template structures. The resulting prompt is then dispatched to the LLM via a secure API interface, which returns an updated, corrected version of the transformation block. The returned code block reflects a semantically corrected or restructured transformation that resolves the identified issue while preserving the logic's intent. The corrected block is then passed back to the refactor manager 506.

Further, the fallback agents 514 and 520 are typically activated when an issue is categorized as generic or when no other specialized agent is applicable. The fallback agents 514 and 520 may address concerns such as syntax corrections, adherence to naming conventions, improvements to code readability, and enforcement of standard programming rules that are not tied to a particular domain. Once invoked, the fallback agents 514 and 520 may evaluate provided code snippet using prompt patterns that are designed to capture common anti-patterns or inconsistencies. The prompts, defined in user_prompts.yaml, serve as templates for generating general improvements. The resulting output is a refactored code snippet that enhances clarity, correctness, or stylistic alignment. The output is then transmitted to the refactor manager 506 for further review or integration into the code repository.

In terms of configuration, the fallback agents 514 and 520 are defined in agents.yaml with flexible or minimal role instructions, allowing the fallback agents 514 and 520 to apply broadly across multiple issue types. The prompts are correspondingly generalized and serve as fallback options when no more specialized corrective path is available. Despite generalized nature, these agents are critical in ensuring codebase uniformity and maintaining baseline quality standards in cases where deeper semantic correction is unnecessary or unavailable.

Further, the refactor manager 506 collects responses (i.e. remediated snippets) from each agent and forwards all agent outputs to the code synthesizer 522 for merging. Once the merged file is produced, the refactor manager 506 writes a final refactored file or code, along with a remediation report summarizing the original validation issues, agent assignments, snippet changes, and success status. Also, the refactor manager stores the final refactored file or code along with the remediation report to the code repository 502. In an aspect, the code synthesizer 522 receives all remediated snippets from the various agents, reassembles them into the original code structure by determining insertion positions (for example via placeholder tokens or metadata), reinserts docstrings or blocks (if they had been temporarily extracted), validates the merged output (e.g. via parsing), and writes the final refactored file.

In some examples, the prompt generation module 210 may be configured to execute a prompt for the code reviewer 508 to analyze the final refactored code and ensure whether errors or issues are resolved. In an aspect, the code reviewer 508 loads configurations identifying file lists (e.g. files_to_run.txt), paths to validation rules, and report directories. Further, the code reviewer 508 initializes a validation runner and then iterates over each source code file in files_to_run.txt. For each file, the code reviewer 508 runs both rule-based static analysis (according to static rules from rules.yaml) and LLM-based semantic validation (by issuing prompts using semantic validation templates). The detected issues are classified into categories such as execution errors, code quality issues, or inconsistencies requiring manual review. Finally, the code reviewer 508 writes a structured validation report (for example in eXtensible Markup Language (XML) or another structured format), which is consumed downstream by the refactor manager 506. For example, the code reviewer 508 determines whether all issues from the report have been fixed. The code reviewer's 508 functions include main( ) as an entry point (loading configuration and triggering validation) and logic.validate( ) which implements rule-based and LLM checks and issue classification.

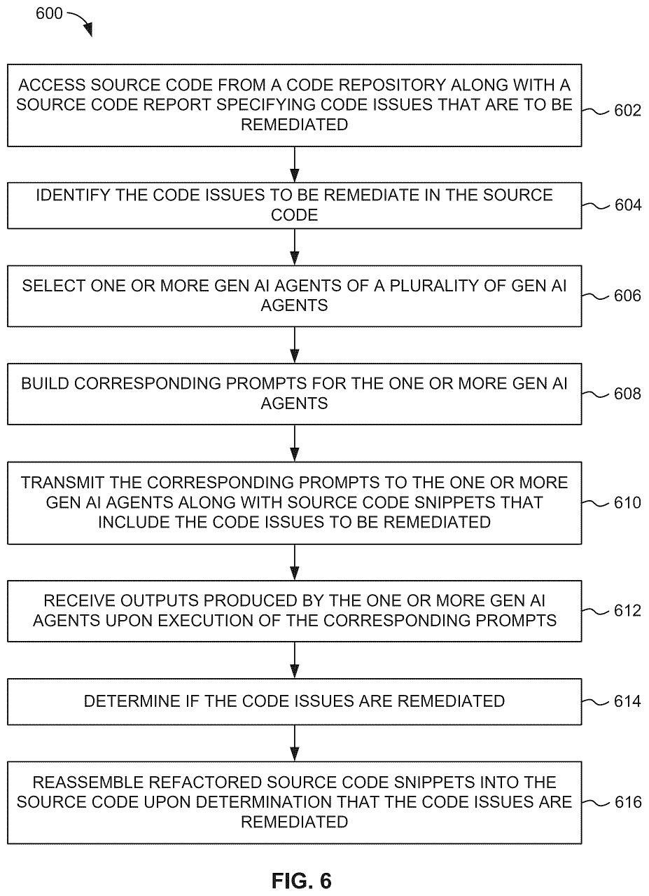

FIG. 6 is a flow diagram that represents an example processor-executable method 600 for performing Gen AI-based multiagent code migration, in accordance with implementations of the present disclosure. In some implementations, the method 600 may be executed by the processor 202 (including the one or more processors), as described in relation to FIGS. 2-5.

In an example implementation, the method 600 may include accessing source code 602 from a code repository along with a source code report specifying code issues that are to be remediated. Further, the method 600 may include identifying code issues 604 to be remediate in the source code. Furthermore, the method 600 may include selecting one or more Gen AI agents 606 of a plurality of Gen AI agents. For example, the plurality of Gen AI based agents are defined by corresponding system prompts and accessible tools. In an aspect, the one or more Gen AI agents are configured for execution of the code conversion tasks that include remediating the code issues. Moreover, the method 600 may include building corresponding prompts 608 for the one or more Gen AI agents. In addition, the method 600 may include transmitting 610 the corresponding prompts to the one or more Gen AI agents along with source code snippets that include the code issues to be remediated. The method 600 may then include receiving outputs 612 produced by the one or more Gen AI agents upon execution of the corresponding prompts. For example, the outputs may include refactored source code snippets with the code issues remediated. Also, the method 600 may include determining 614 if the code issues are remediated.

Further, the method 600 may include reassembling the refactored source code snippets 616 into the source code upon the determination that the code issues are remediated. In an aspect, the method of reassembling the refactored source code snippets 616 may include generating merged code where the refactored source code snippets are inserted into corresponding placeholder tokens used for the source code snippets that include the code issues to be remediated. In some examples, the merged code including the refactored source code snippets inserted into corresponding placeholder tokens in the source code is further validated.

Implementations of the present disclosure enables organizations to enforce granular privacy and governance policies, such as restricting certain types of data access to specific agents or incorporating human-in-the-loop validation at designated stages. In addition to enhanced explainability and risk mitigation, the present disclosure offers significant performance improvements. In one implementation, the multiagent code migration achieved approximately 50% reduction in manual effort compared to conventional monolithic approaches, while simultaneously increasing success rates and reducing iteration cycles.

Furthermore, the present disclosure facilitates better bias isolation and mitigation by enabling targeted retraining or replacement of individual agents rather than altering an entire model pipeline. The disclosed system is particularly well-suited for enterprise, regulated, or mission-critical environments where transparency, adaptability, and system trust are paramount. By separating concerns across agents and providing a structured orchestration mechanism, the present disclosure offers a robust foundation for building and scaling LLM-based solutions in a safe, controllable, and auditable manner. The structured orchestration mechanism may enable clear traceability from input to output, which is critical for debugging, auditing, and regulatory compliance. The mechanism also enhances scalability, as new agents can be introduced or existing ones replaced to accommodate new tasks or domains with minimal integration effort. The use of the orchestration mechanism for agent coordination introduces a structured control layer, which facilitates dynamic task execution and adaptive agent invocation based on input context or system logic, thereby increasing operational efficiency.

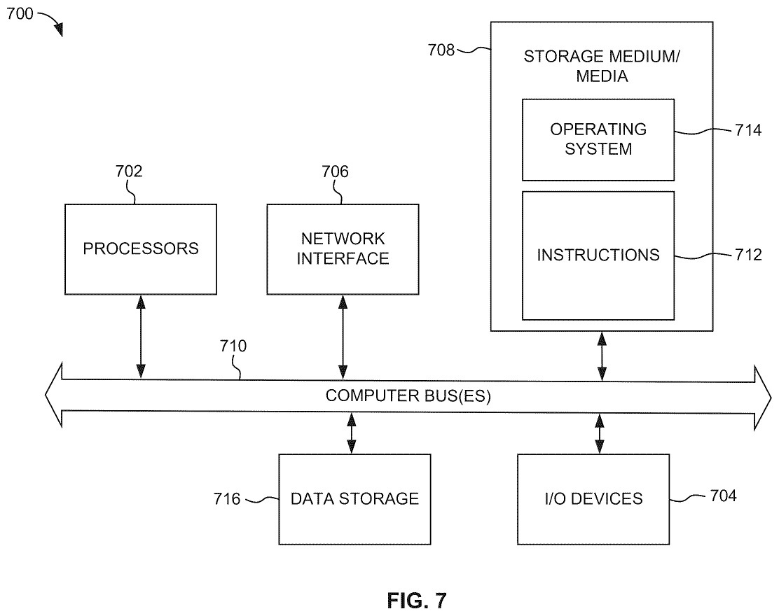

FIG. 7 illustrates a computer system 700 (i.e., the Gen AI-based code migration system 104) that may be used to implement the method for performing Gen AI-based multiagent code migration, in accordance with implementations of the present disclosure. More particularly, computing machines such as desktops, laptops, smartphones, tablets, and wearables which may be used to perform the software testing. The computer system 700 may include additional components not shown and that some of the process components described may be removed and/or modified. In another example, a computer system 700 may be deployed on external-cloud platforms such as cloud, internal corporate cloud computing clusters, organizational computing resources, and/or the like.

The computer system 700 includes processor(s) 702, such as a central processing unit, ASIC or another type of processing circuit, input/output devices 704, such as a display, mouse keyboard, etc., a network interface 706, such as a Local Area Network (LAN), a wireless 702.11x LAN, a 3G or 4G mobile WAN or a WiMax WAN, and a computer-readable medium 708. Each of these components may be operatively coupled to a bus 710. The computer-readable medium 708 may be any suitable medium that participates in providing instructions to the processor(s) 702 for execution. For example, the computer-readable medium 708 may be non-transitory or non-volatile medium, such as a magnetic disk or solid-state non-volatile memory or volatile medium such as RAM. The instructions or modules stored on the computer-readable medium 708 may include machine-readable instructions 712 executed by the processor(s) 702 that cause the processor(s) 702 to perform the methods and functions of the system 104.

The system 700 may be implemented as software stored on a non-transitory processor-readable medium and executed by the processor(s) 702. For example, the computer-readable medium 708 may store an operating system 714, such as MAC OS, MS WINDOWS, UNIX, or LINUX, and code, for the system 700. The operating system 714 may be multi-user, multiprocessing, multitasking, multithreading, real-time, and the like. For example, during runtime, the operating system 714 is running and the code for the computer system 700 is executed by the processor(s) 702.

The computer system 700 may include a data storage 716, which may include non-volatile data storage. The data storage 716 stores any data used or generated by the system 104. The network interface 706 connects the computer system 700 to internal systems for example, via a LAN. Also, the network interface 706 may connect the computer system 700 to the Internet. For example, the computer system 700 may connect to web browsers and other external applications and systems via the network interface 706.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, the system 104). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer includes or is operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor(s) 702 and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet. The computing system may include clients and servers. A client and server are generally remote from each other and interact through a communication network. The relationship between client and server arises by virtue of computer programs running on the respective computers and having a client-server relationship with each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination with a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together into a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A Generative Artificial Intelligence (Gen AI) based code migration system, comprising:
at least one hardware processor; and
at least one non-transitory processor-readable medium storing,
a plurality of Gen AI agents that enable remediation of different types of code issues in source code, and
instructions to be executed by the at least one hardware processor to:
execute a system prompt for a code refactoring agent from the plurality of Gen AI agents, and
the execution of the system prompt for the code refactoring agent further causes the at least one hardware processor to:
access the source code from a code repository along with a source code report specifying code issues that are to be remediated;
identify, by parsing the source code report, the code issues to be remediated in the source code;
select one or more Gen AI agents of the plurality of Gen AI agents,
wherein the one or more Gen AI agents are configured for remediating at least one of the code issues;
build corresponding prompts for the one or more Gen AI agents, wherein the corresponding prompts include source code snippets with the at least one code issue to be remediated by corresponding Gen AI agents of the one or more Gen AI agents;
transmit the corresponding prompts to the one or more Gen AI agents;
receive outputs produced by the one or more Gen AI agents upon execution of the corresponding prompts,
wherein the outputs include refactored source code snippets with the at least one code issue remediated;
validate the refactored source code snippets; and
reassemble the source code by replacing the source code snippets including the at least one code issue with the refactored source code snippets.

2. The Gen AI based code migration system of claim 1, wherein the plurality of Gen AI agents implement different types of Large Language Models (LLMs).

3. The Gen AI based code migration system of claim 1, wherein to access the source code report the at least one non-transitory processor-readable medium stores further instructions that cause the at least one hardware processor to:
execute rule-based and semantic validation over the source code; and
classify the at least one code issue into one or more of the different types of code issues.

4. The Gen AI based code migration system of claim 3, wherein the different types of code issues comprise execution errors, code quality errors and inconsistencies requiring manual review.

5. The Gen AI based code migration system of claim 3, wherein to select the one or more of Gen AI agents the at least one non-transitory processor-readable medium stores further instructions that cause the at least one hardware processor to:
identify corresponding ones of the one or more Gen AI agents that are configured for remediating types of the at least one code issue identified in the source code.

6. The Gen AI based code migration system of claim 3, wherein to transmit the corresponding prompts to the one or more Gen AI agents the at least one non-transitory processor-readable medium stores further instructions that cause the at least one hardware processor to:
transmit the corresponding prompts to the one or more Gen AI agents via Large Language Model (LLM) Application Programming Interfaces (APIs).

7. The Gen AI based code migration system of claim 1, wherein the at least one non-transitory processor-readable medium stores further instructions that cause the at least one hardware processor to:
execute a prompt generated by the code refactoring agent for an import statement expert agent for correcting incorrect import statements in the source code,
wherein the plurality of Gen AI agents include at least the import statement expert agent configured for remediating import statements.

8. The Gen AI based code migration system of claim 7, wherein to correct the incorrect import statements the at least one non-transitory processor-readable medium stores further instructions that cause the at least one hardware processor to:
determine that a task for correcting incorrect import statements is delegated by the code refactoring agent;
load prompt template for import-related refactoring; and
provide a structured prompt and at least a snippet of the source code including the incorrect import statements to an LLM implemented by the import statement expert agent.

9. The Gen AI based code migration system of claim 8, wherein to correct the incorrect import statements the at least one non-transitory processor-readable medium stores further instructions that cause the at least one hardware processor to:
transmit remediated source code snippets including corrected import statements to the code refactoring agent.

10. The Gen AI based code migration system of claim 1, wherein the at least one non-transitory processor-readable medium stores further instructions that cause the at least one hardware processor to:
execute a prompt generated by the code refactoring agent for a parameters expert agent that remediates function parameter issues in the source code,
wherein the plurality of Gen AI agents include at least the parameters expert agent.

11. The Gen AI based code migration system of claim 10, wherein to remediate the function parameter issues the at least one non-transitory processor-readable medium stores further instructions that cause the at least one hardware processor to:
receive at the parameters expert agent, one or more source code snippets including the function parameter issues;
load a tailored prompt for parameter repair; and
generate the one or more source code snippets with the function parameter issues remediated.

12. The Gen AI based code migration system of claim 11, wherein to correct the function parameter issues the at least one non-transitory processor-readable medium stores further instructions that cause the at least one hardware processor to:
transmit the one or more remediated source code snippets including remediated function parameter issues to the code refactoring agent.

13. The Gen AI based code migration system of claim 1, wherein the at least one non-transitory processor-readable medium stores further instructions that cause the at least one hardware processor to:
execute a prompt generated by the code refactoring agent for a design expert agent that remediates design issues in the source code,
wherein the plurality of Gen AI agents include at least the design expert agent.

14. The Gen AI based code migration system of claim 13, wherein to remediate the design issues the at least one non-transitory processor-readable medium stores further instructions that cause the at least one hardware processor to:
evaluate one or more of class structure, object hierarchy and reuse patterns in source code snippets to be remediated;
apply design-specific rules retrieved from a rules file and semantic prompts from the prompt generated by the code refactoring agent;
remediate the design issues based on the rules file and the semantic prompts; and
transmit the remediated source code snippets to the code refactoring agent with design issues remediated.

15. The Gen AI based code migration system of claim 1, wherein the plurality of Gen AI agents comprising one or more multi-purpose agents activated for the code issues that include syntax corrections, naming convention checks, readability improvements and rule enforcement.

16. A processor-executable code migration method comprising:
accessing, by at least one processor, source code from a code repository along with a source code report specifying code issues that are to be remediated;
identifying, by the at least one processor, the code issues to be remediate in the source code;
selecting, by the at least one processor, one or more Gen AI agents of a plurality of Gen AI agents,
wherein the one or more Gen AI agents are configured for execution of the code conversion tasks that include remediating the code issues;
building, by the at least one processor, corresponding prompts for the one or more Gen AI agents;
transmitting, by the at least one processor, the corresponding prompts to the one or more Gen AI agents along with source code snippets that include the code issues to be remediated;
receiving, by the at least one processor, outputs produced by the one or more Gen AI agents upon execution of the corresponding prompts,
wherein the outputs include refactored source code snippets with the code issues remediated;
determining, by the at least one processor, if the code issues are remediated; and
reassembling, by the at least one processor, the refactored source code snippets into the source code upon determination that the code issues are remediated.

17. The processor-executable method of claim 16, wherein to reassembling the refactored source code snippets into the source code further comprises:
generating, by the at least one processor, merged code where the refactored source code snippets are inserted into corresponding placeholder tokens used for the source code snippets that include the code issues to be remediated.

18. The processor-executable method of claim 16, further comprising:
further validating, by the at least one processor, the merged code including the refactored source code snippets inserted into corresponding placeholder tokens in the source code.

19. A non-transitory processor-readable storage medium comprising:
a plurality of Gen AI agents including configured for remediation of code issues in source code, and
processor-readable instructions that cause a processor to:
execute a system prompt for a code refactoring agent included in the plurality of Gen AI agents,
wherein the execution of the system prompt for the code refactoring agent further causes the at least one hardware processor to:
access the source code from a code repository along with a source code report specifying code issues that are to be remediated;
identify, by parsing the source code report, the code issues to be remediated in the source code;
select one or more Gen AI agents of the plurality of Gen AI agents,
wherein the one or more Gen AI agents are configured for remediating at least one of the code issues;
build corresponding prompts for the one or more Gen AI agents, wherein the corresponding prompts include source code snippets with the code issues to be remediated by corresponding Gen AI agents of the one or more Gen AI agents;
transmit the corresponding prompts to the one or more Gen AI agents;
receive outputs produced by the one or more Gen AI agents upon execution of the corresponding prompts,
wherein the outputs include refactored source code snippets with the code issues remediated;
validate the refactored source code snippets; and
replace the source code snippets including the code issues with the refactored source code snippets upon the validation of the refactored source code snippets.

20. The non-transitory processor-readable storage medium of claim 19, wherein the plurality of Gen AI based agents are further defined by corresponding system prompts and accessible tools.
